(19) United States
(12) Patent Application Publication
(10) Pub. No.: US 2026/0252729 A1
(43) Pub. Date: Aug. 27, 2026

(54) System, Method, and Computer Program Product for Privacy-Preserving Synthetic Data Generation

(71) Applicant: Visa International Service Association, San Francisco, CA (US)

(72) Inventors: Martin David Izenson, Foster City, CA (US); Akshay Dan Bhavish Juleemun, Burlingame, CA (US); Partha Saha, San Mateo, CA (US); Pamela Bagh, Dublin, CA (US); Harleen Kaur, Cupertino, CA (US); Varun Sharma, Foster City, CA (US); Satish Babu Bellapu, San Ramon, CA (US); Sabrina Khandwalla, Oakland, CA (US); Seon Kang, Seattle, WA (US); Anderson Clayton Alves Nascimento, University Place, WA (US); Xueping Li, Sunnyvale, CA (US)

(21) Appl. No.: 19/548,056

(22) Filed: Feb. 24, 2026

Related U.S. Application Data
(60) Provisional application No. 63/762,359, filed on Feb. 24, 2025.

(51) Int. Cl. G06F 21/62; G06N 20/20

(52) U.S. Cl. CPC G06F 21/6245; G06N 20/20

(57) ABSTRACT

Systems, methods, and computer program products are provided for privacy-preserving synthetic data generation. An example method includes receiving a request for generation of synthetic data from a user. A plurality of possible parameters for the synthetic data are generated. At least one parameter is determined based on the possible parameters and at least one input. At least one machine learning model is determined from a plurality of machine learning models based on the parameter(s). The machine learning models are trained based on real data. The synthetic data is generated based on the machine learning model(s) and the parameter(s). The synthetic data is verified based on at least one of the parameter(s), the real data, or any combination thereof. In response to verifying the synthetic data, the synthetic data is communicated to the user.

### CROSS-REFERENCE TO RELATED APPLICATION

This application claims the benefit of U.S. Provisional Patent Application No. 63/762,359, filed Feb. 24, 2025, the disclosure of which is hereby incorporated by reference in its entirety.

### BACKGROUND

### 1. Technical Field

This disclosure relates generally to synthetic data generation and, in non-limiting embodiments or aspects, to systems, methods, and computer program products for privacy-preserving synthetic data generation.

### 2. Technical Considerations

Data can be useful for many applications. However, real data can include private (e.g., sensitive, confidential, and/or protected) information, such as personally identifiable information (PII), financial information, medical or health-related information, etc. Sharing of real data that includes such information or using such real data for certain applications is undesirable and/or impermissible. Even if the real data is anonymized or de-identified, there is still a risk of re-identification of such data. For example, if certain patterns can be recognized or reconstructed in the anonymized data and/or if the anonymized data is cross-referenced with another dataset (e.g., publicly available data), the anonymized individuals and/or entities may be identified.

Synthetic data can be generated. However, if the synthetic data does not sufficiently reflect real data, the usefulness of such synthetic data in many applications will be lacking (e.g., limited, reduced, non-existent, and/or the like). For example, certain techniques of generating synthetic transaction data may rely on random number generation or statistical-based techniques, which may fail to account for (e.g., contain, accurately reflect, and/or the like) patterns in the real data and/or may include feature patterns that are not as variable as real data (e.g., not the same feature distribution). Synthetic data generated using such techniques, therefore, is insufficient for many applications.

### SUMMARY

Accordingly, provided are improved systems, methods, and computer program products for privacy-preserving synthetic data generation.

According to non-limiting embodiments or aspects, provided is a method for privacy-preserving synthetic data generation. An example method may include receiving a request for generation of synthetic data from a user. A plurality of possible parameters for the synthetic data may be generated. At least one parameter may be determined based on the plurality of possible parameters and at least one input from the user. At least one machine learning model may be determined from a plurality of machine learning models based on the at least one parameter. The plurality of machine learning models may be trained based on real data. The synthetic data may be generated based on the at least one machine learning model and the at least one parameter. The synthetic data may be verified based on at least one of: the at least one parameter, the real data, or any combination thereof. In response to verifying the synthetic data, the synthetic data may be communicated to the user.

In some non-limiting embodiments or aspects, the plurality of possible parameters may include at least one of the following: an engine parameter associated with one or more of the plurality of machine learning models, an operational parameter, a file location parameter, an access parameter, a descriptive parameter associated with at least a portion of the real data, field grouping data associated with at least two fields of the real data, a privacy parameter, an output of a large language model, or any combination thereof.

In some non-limiting embodiments or aspects, the field grouping data may be based on a decision tree based on the at least two fields of the real data.

In some non-limiting embodiments or aspects, the output of the large language model may be associated with at least one recommended parameter based on at least one of the following: the real data, the at least one input from the user, or any combination thereof.

In some non-limiting embodiments or aspects, each respective machine learning model of the plurality of machine learning models may be trained based on a respective portion of the real data associated with a respective cluster of entities of a plurality of entities associated with the real data.

In some non-limiting embodiments or aspects, the method may further include determining at least one metric associated with the synthetic data and at least one metric associated with the real data. Verifying the synthetic data may include comparing the at least one metric associated with the synthetic data and the at least one metric associated with the real data.

In some non-limiting embodiments or aspects, the method may further include determining a privacy re-identification risk associated with the synthetic data. Verifying the synthetic data may be further based on the privacy re-identification risk.

In some non-limiting embodiments or aspects, the method may further include determining at least one metric associated with the synthetic data. Verifying the synthetic data may be based on the at least one metric associated with the synthetic data and the privacy re-identification risk.

In some non-limiting embodiments or aspects, the method may further include training at least one other machine learning model based on the synthetic data.

In some non-limiting embodiments or aspects, the method may further include receiving a transaction message and performing at least one action based on the transaction message and the at least one other machine learning model trained based on the synthetic data.

In some non-limiting embodiments or aspects, the at least one other machine learning model may include a fraud detection model. Performing the at least one action may include denying a transaction associated with the transaction message based on inputting an input based on the transaction message to the fraud detection model trained based on the synthetic data.

According to non-limiting embodiments or aspects, provided is a system for privacy-preserving synthetic data generation. An example system may include at least one processor, which may be configured to receive a request for generation of synthetic data from a user. The at least one processor may be configured to generate a plurality of possible parameters for the synthetic data. The at least one processor may be configured to determine at least one parameter based on the plurality of possible parameters and at least one input from the user. The at least one processor may be configured to determine at least one machine learning model from a plurality of machine learning models based on the at least one parameter. The plurality of machine learning models may have been trained based on real data. The at least one processor may be configured to generate the synthetic data based on the at least one machine learning model and the at least one parameter. The at least one processor may be configured to verify the synthetic data based on at least one of: the at least one parameter, the real data, or any combination thereof. The at least one processor may be configured to communicate the synthetic data to the user in response to verifying the synthetic data.

In some non-limiting embodiments or aspects, the plurality of possible parameters may include at least one of the following: an engine parameter associated with one or more of the plurality of machine learning models, an operational parameter, a file location parameter, an access parameter, a descriptive parameter associated with at least a portion of the real data, field grouping data associated with at least two fields of the real data, a privacy parameter, an output of a large language model, or any combination thereof.

In some non-limiting embodiments or aspects, the field grouping data may be based on a decision tree based on the at least two fields of the real data.

In some non-limiting embodiments or aspects, the output of the large language model may be associated with at least one recommended parameter based on at least one of the following: the real data, the at least one input from the user, or any combination thereof.

In some non-limiting embodiments or aspects, each respective machine learning model of the plurality of machine learning models may be trained based on a respective portion of the real data associated with a respective cluster of entities of a plurality of entities associated with the real data.

In some non-limiting embodiments or aspects, the at least one processor may be further configured to determine at least one metric associated with the synthetic data and at least one metric associated with the real data, wherein verifying the synthetic data comprises comparing the at least one metric associated with the synthetic data and the at least one metric associated with the real data.

In some non-limiting embodiments or aspects, the at least one processor may be further configured to determine a privacy re-identification risk associated with the synthetic data, wherein verifying the synthetic data is further based on the privacy re-identification risk.

In some non-limiting embodiments or aspects, the at least one processor may be further configured to train at least one other machine learning model based on the synthetic data.

In some non-limiting embodiments or aspects, the at least one processor may be further configured to receive a transaction message and perform at least one action based on the transaction message and the at least one other machine learning model trained based on the synthetic data.

In some non-limiting embodiments or aspects, the at least one other machine learning model may include a fraud detection model. Performing the at least one action may include denying a transaction associated with the transaction message based on inputting an input based on the transaction message to the fraud detection model trained based on the synthetic data.

According to non-limiting embodiments or aspects, provided is a computer program product for privacy-preserving synthetic data generation. An example computer program product may include at least one non-transitory computer-readable medium including program instructions that, when executed by at least one processor, cause the at least one processor to receive a request for generation of synthetic data from a user. The program instructions, when executed by at least one processor, may cause the at least one processor to generate a plurality of possible parameters for the synthetic data. The program instructions, when executed by at least one processor, may cause the at least one processor to determine at least one parameter based on the plurality of possible parameters and at least one input from the user. The program instructions, when executed by at least one processor, may cause the at least one processor to determine at least one machine learning model from a plurality of machine learning models based on the at least one parameter, the plurality of machine learning models trained based on real data. The program instructions, when executed by at least one processor, may cause the at least one processor to generate the synthetic data based on the at least one machine learning model and the at least one parameter. The program instructions, when executed by at least one processor, may cause the at least one processor to verify the synthetic data based on at least one of: the at least one parameter, the real data, or any combination thereof. The program instructions, when executed by at least one processor, may cause the at least one processor to communicate the synthetic data to the user in response to verifying the synthetic data.

According to non-limiting embodiments or aspects, provided is a system for privacy-preserving synthetic data generation. An example system may include at least one processor configured to perform any of the methods described herein.

According to non-limiting embodiments or aspects, provided is a computer program product for privacy-preserving synthetic data generation. An example computer program product may include at least one non-transitory computer-readable medium including program instructions that, when executed by at least one processor, cause the at least one processor to perform any of the methods described herein.

Further non-limiting embodiments or aspects are set forth in the following numbered clauses:
Clause 1: A computer-implemented method, comprising: receiving, with at least one processor, a request for generation of synthetic data from a user; generating, with at least one processor, a plurality of possible parameters for the synthetic data; determining, with at least one processor, at least one parameter based on the plurality of possible parameters and at least one input from the user; determining, with at least one processor, at least one machine learning model from a plurality of machine learning models based on the at least one parameter, the plurality of machine learning models trained based on real data; generating, with at least one processor, the synthetic data based on the at least one machine learning model and the at least one parameter; verifying, with at least one processor, the synthetic data based on at least one of: the at least one parameter, the real data, or any combination thereof; and in response to verifying the synthetic data, communicating, with at least one processor, the synthetic data to the user.
Clause 2: The method of clause 1, wherein the plurality of possible parameters comprises at least one of the following: an engine parameter associated with one or more of the plurality of machine learning models, an operational parameter, a file location parameter, an access parameter, a descriptive parameter associated with at least a portion of the real data, field grouping data associated with at least two fields of the real data, a privacy parameter, an output of a large language model, or any combination thereof.
Clause 3: The method of clause 1 or clause 2, wherein the field grouping data is based on a decision tree based on the at least two fields of the real data.
Clause 4: The method of any of clauses 1-3, wherein the output of the large language model is associated with at least one recommended parameter based on at least one of the following: the real data, the at least one input from the user, or any combination thereof.
Clause 5: The method of any of clauses 1-4, wherein each respective machine learning model of the plurality of machine learning models is trained based on a respective portion of the real data associated with a respective cluster of entities of a plurality of entities associated with the real data.
Clause 6: The method of any of clauses 1-5, further comprising determining at least one metric associated with the synthetic data and at least one metric associated with the real data, wherein verifying the synthetic data comprises comparing the at least one metric associated with the synthetic data and the at least one metric associated with the real data.
Clause 7: The method of any of clauses 1-6, further comprising determining a privacy re-identification risk associated with the synthetic data, wherein verifying the synthetic data is further based on the privacy re-identification risk.
Clause 8: The method of any of clauses 1-7, further comprising determining at least one metric associated with the synthetic data, wherein verifying the synthetic data is based on the at least one metric associated with the synthetic data and the privacy re-identification risk.
Clause 9: The method of any of clauses 1-8, further comprising: training at least one other machine learning model based on the synthetic data.
Clause 10: The method of any of clauses 1-9, further comprising: receiving a transaction message; and performing at least one action based on the transaction message and the at least one other machine learning model trained based on the synthetic data.
Clause 11: The method of any of clauses 1-10, wherein the at least one other machine learning model comprises a fraud detection model, and wherein performing the at least one action comprises denying a transaction associated with the transaction message based on inputting an input based on the transaction message to the fraud detection model trained based on the synthetic data.
Clause 12: A system, comprising: at least one processor configured to: receive a request for generation of synthetic data from a user; generate a plurality of possible parameters for the synthetic data; determine at least one parameter based on the plurality of possible parameters and at least one input from the user; determine at least one machine learning model from a plurality of machine learning models based on the at least one parameter, the plurality of machine learning models trained based on real data; generate the synthetic data based on the at least one machine learning model and the at least one parameter; verify the synthetic data based on at least one of: the at least one parameter, the real data, or any combination thereof; and in response to verifying the synthetic data, communicate the synthetic data to the user.
Clause 13: The system of clause 12, wherein the plurality of possible parameters comprises at least one of the following: an engine parameter associated with one or more of the plurality of machine learning models, an operational parameter, a file location parameter, an access parameter, a descriptive parameter associated with at least a portion of the real data, field grouping data associated with at least two fields of the real data, a privacy parameter, an output of a large language model, or any combination thereof.
Clause 14: The system of clause 12 or clause 13, wherein the field grouping data is based on a decision tree based on the at least two fields of the real data.
Clause 15: The system of any of clauses 12-14, wherein the output of the large language model is associated with at least one recommended parameter based on at least one of the following: the real data, the at least one input from the user, or any combination thereof.
Clause 16: The system of any of clauses 12-15, wherein each respective machine learning model of the plurality of machine learning models is trained based on a respective portion of the real data associated with a respective cluster of entities of a plurality of entities associated with the real data.
Clause 17: The system of any of clauses 12-16, wherein the at least one processor is further configured to: determine at least one metric associated with the synthetic data and at least one metric associated with the real data, wherein verifying the synthetic data comprises comparing the at least one metric associated with the synthetic data and the at least one metric associated with the real data.
Clause 18: The system of any of clauses 12-17, wherein the at least one processor is further configured to: determine a privacy re-identification risk associated with the synthetic data, wherein verifying the synthetic data is further based on the privacy re-identification risk.
Clause 19: The system of any of clauses 12-18, wherein the at least one processor is further configured to: train at least one other machine learning model based on the synthetic data.
Clause 20: The system of any of clauses 12-19, wherein the at least one processor is further configured to: receive a transaction message; and perform at least one action based on the transaction message and the at least one other machine learning model trained based on the synthetic data.
Clause 21: The system of any of clauses 12-20, wherein the at least one other machine learning model comprises a fraud detection model, and wherein performing the at least one action comprises denying a transaction associated with the transaction message based on inputting an input based on the transaction message to the fraud detection model trained based on the synthetic data.
Clause 22: A computer program product comprising at least one non-transitory computer-readable medium including program instructions that, when executed by at least one processor, cause the at least one processor to: receive a request for generation of synthetic data from a user; generate a plurality of possible parameters for the synthetic data; determine at least one parameter based on the plurality of possible parameters and at least one input from the user; determine at least one machine learning model from a plurality of machine learning models based on the at least one parameter, the plurality of machine learning models trained based on real data; generate the synthetic data based on the at least one machine learning model and the at least one parameter; verify the synthetic data based on at least one of: the at least one parameter, the real data, or any combination thereof; and in response to verifying the synthetic data, communicate the synthetic data to the user.
Clause 23: A system, comprising: at least one processor configured to perform the method of any of clauses 1-11.
Clause 24: A computer program product comprising at least one non-transitory computer-readable medium including program instructions that, when executed by at least one processor, cause the at least one processor to perform the method of any of clauses 1-11.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for privacy-preserving synthetic data generation, according to some non-limiting embodiments or aspects;

FIG. 2 is a flow diagram of a method for privacy-preserving synthetic data generation, according to some non-limiting embodiments or aspects;

FIG. 3 is a diagram of an example payment processing network in which systems, methods, and/or computer program products, described herein, may be implemented, according to some non-limiting embodiments or aspects;

FIG. 4 is a schematic diagram of example components of one or more devices of FIG. 1 and/or FIG. 3, according to some non-limiting embodiments or aspects;

FIGS. 5A-5E are schematic diagrams of a system for privacy-preserving synthetic data generation, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the term “payment device” may refer to a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, POS devices, mobile devices, etc.) directly or indirectly communicating in the network environment may constitute a “system.”

As used herein, the term “system” may refer to one or more computing devices or combinations of computing devices and/or components of such (e.g., processors, servers, client devices, software applications, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the disclosed subject matter are directed to systems, methods, and computer program products for privacy-preserving synthetic data generation. For example, non-limiting embodiments or aspects of the disclosed subject matter provide receiving a request for generation of synthetic data from a user. A plurality of possible parameters for the synthetic data may be generated. At least one parameter may be determined based on the plurality of possible parameters and at least one input from the user. At least one machine learning model may be determined from a plurality of machine learning models based on the at least one parameter. The plurality of machine learning models may be trained based on real data. The synthetic data may be generated based on the at least one machine learning model and the at least one parameter. The synthetic data may be verified based on at least one of: the at least one parameter, the real data, or any combination thereof. In response to verifying the synthetic data, the synthetic data may be communicated to the user. In this way, the generation of application-specific synthetic data that maintains sufficient quality to use for many applications (e.g., research and/or training of downstream machine learning models) without compromising privacy (e.g., personally identifiable information (PII) or other sensitive information) of the real data is enabled. Moreover, the disclosed subject matter is flexible in that it can be used with different data sources and can select from among different previously trained models based on the parameters of the request.

Further, non-limiting embodiments or aspects of the disclosed subject matter provide that the plurality of possible parameters may include at least one of the following: an engine parameter associated with one or more of the plurality of machine learning models, an operational parameter, a file location parameter, an access parameter, a descriptive parameter associated with at least a portion of the real data, field grouping data associated with at least two fields of the real data, a privacy parameter, an output of a large language model, or any combination thereof. For example, the field grouping data may be based on a decision tree based on the at least two fields of the real data. Additionally or alternatively, the output of the large language model may be associated with at least one recommended parameter based on at least one of the following: the real data, the at least one input from the user, or any combination thereof. In this way, the GenAI recommended parameters can further improve accuracy of the synthetic data. For example, the recommended parameters (e.g., large language model (LLM) outputs) can identify hierarchies or dependencies in the data and/or construct decision trees based on such identifications.

In addition, non-limiting embodiments or aspects of the disclosed subject matter provide that each respective machine learning model of the plurality of machine learning models may be trained based on a respective portion of the real data associated with a respective cluster of entities of a plurality of entities associated with the real data. In this way, the various machine learning models may be trained based on application specific clusters (e.g., geographic clusters, demographic clusters, and/or the like), which may further improve the accuracy and quality of the generated synthetic data for the particular application.

Moreover, non-limiting embodiments or aspects of the disclosed subject matter provide that the method may further include determining at least one metric associated with the synthetic data and at least one metric associated with the real data. Verifying the synthetic data may include comparing the at least one metric associated with the synthetic data and the at least one metric associated with the real data. Additionally or alternatively, the method may further include determining a privacy re-identification risk associated with the synthetic data, and verifying the synthetic data may be further based on the privacy re-identification risk. Additionally or alternatively, the method may further include determining at least one metric associated with the synthetic data, and verifying the synthetic data is based on the at least one metric associated with the synthetic data and the privacy re-identification risk. In this way, the verification process can be customized to balance privacy with quality of the synthetic data (e.g., increased privacy may correlate with reduced accuracy, and vice versa).

The synthetic data generated based on the techniques described herein may be used in many useful applications. For example, the synthetic data may be used for research, such as researching the impact of a natural disaster (e.g., flood, earthquake, etc.) or a large event in a specific geographical region. The generated synthetic data can be used for training downstream machine learning models (e.g., models for clearing predictions, fraud detection, anomaly detection, pattern recognition, trend identification, authentication/identity verification, risk prediction, product recommendation, and/or the like) without compromising privacy. For the purpose of illustration, non-limiting embodiments or aspects of the disclosed subject matter provide for training at least one other (e.g., downstream) machine learning model based on the synthetic data. Additionally, a transaction message may be received and at least one action may be performed based on the transaction message and the other (e.g., downstream) machine learning model(s) trained based on the synthetic data. For example, the other machine learning model(s) may include a fraud detection model, and performing the action(s) may include denying a transaction associated with the transaction message based on inputting an input based on the transaction message to the fraud detection model trained based on the synthetic data (e.g., the fraud detection model may generate a prediction that the transaction is fraudulent, and the transaction may therefore be denied).

In some non-limiting embodiments or aspects, the disclosed subject matter may enable generating synthetic data when relevant patterns are sparse or missing from the real data. For example, the disclosed subject matter may enable generating rare patterns (e.g., fraud patterns, money laundering patterns, and/or the like) that may be difficult to identify in and/or not included in real data. Additionally, the synthetic data generated as described herein can mitigate class imbalance, e.g., when real data associated with one outcome (e.g., non-fraudulent) greatly outweighs real data associated with another outcome (e.g., fraudulent).

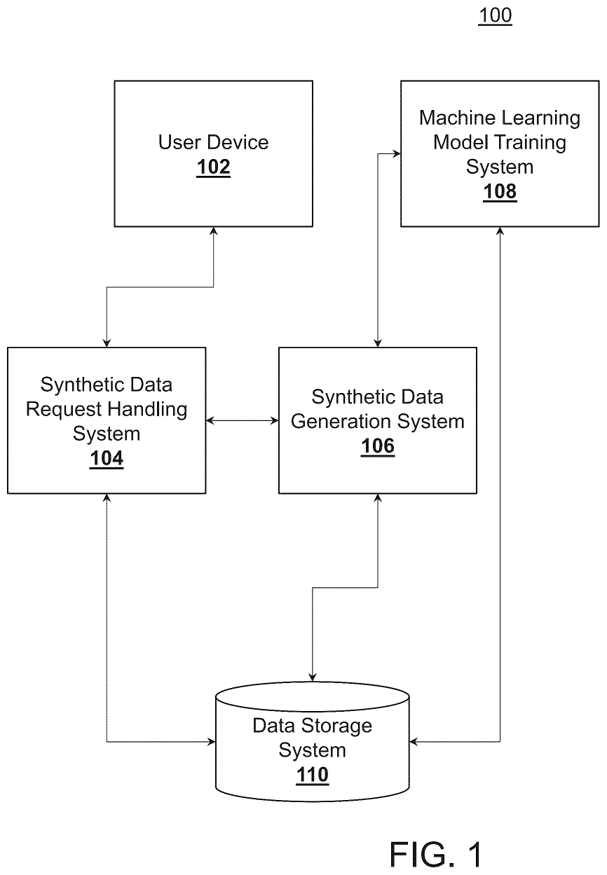

Referring now to FIG. 1, shown is an example system 100 for privacy-preserving synthetic data generation, according to some non-limiting embodiments or aspects. As shown in FIG. 1, system 100 may include user device 102, synthetic data request handling system 104, synthetic data generation system 106, machine learning model training system 108, and/or data storage system 110.

User device 102 may include one or more devices capable of receiving information from and/or communicating information to synthetic data request handling system 104, synthetic data generation system 106, machine learning model training system 108, and/or data storage system 110 (e.g., directly via wired or wireless communication, indirectly, via a public and/or private communication network connection, and/or the like). For example, as shown in FIG. 1, user device 102 may be in communication with synthetic data request handling system 104. In some non-limiting embodiments or aspects, user device 102 may include a computing device, such as a computer, a portable computer, a laptop computer, a tablet computer, a mobile device, a cellular phone, a smartphone, a wearable device (e.g., watches, glasses, lenses, clothing, and/or the like), a PDA, and/or other like devices. In some non-limiting embodiments or aspects, user device 102 may include a device capable of receiving information from and/or communicating information to other user devices 102 (e.g., directly via wired or wireless communication, indirectly, via a public and/or private communication network connection, via a short-range communication connection, and/or the like).

Synthetic data request handling system 104 may include one or more devices capable of receiving information from and/or communicating information to user device 102, synthetic data generation system 106, machine learning model training system 108, and/or data storage system 110 (e.g., directly via wired or wireless communication, indirectly, via a public and/or private communication network connection, and/or the like). For example, as shown in FIG. 1, synthetic data request handling system 104 may be in communication with synthetic data generation system 106 and/or data storage system 110. In some non-limiting embodiments or aspects, synthetic data request handling system 104 may include a computing device, such as a server, a group of servers, a computer, a group of computers, and/or other like devices. In some non-limiting embodiments or aspects, synthetic data request handling system 104 may be in communication with a data storage device (e.g., data storage system 110), which may be local or remote to synthetic data request handling system 104. In some non-limiting embodiments or aspects, synthetic data request handling system 104 may be capable of receiving information from, storing information in, communicating information to, or searching information stored in the data storage device (e.g., data storage system 110). In some non-limiting embodiments or aspects, synthetic data request handling system 104 may be associated with a transaction service provider, as described herein.

Synthetic data generation system 106 may include one or more devices capable of receiving information from and/or communicating information to user device 102, synthetic data request handling system 104, machine learning model training system 108, and/or data storage system 110 (e.g., directly via wired or wireless communication, indirectly, via a public and/or private communication network connection, and/or the like). For example, as shown in FIG. 1, synthetic data generation system 106 may be in communication with synthetic data request handling system 104, machine learning model training system 108, and/or data storage system 110. In some non-limiting embodiments or aspects, synthetic data generation system 106 may include a computing device, such as server, a group of servers, a computer, a group of computers, and/or other like devices. In some non-limiting embodiments or aspects, synthetic data generation system 106 may be in communication with a data storage device (e.g., data storage system 110), which may be local or remote to synthetic data generation system 106. In some non-limiting embodiments or aspects, synthetic data generation system 106 may be capable of receiving information from, storing information in, communicating information to, or searching information stored in the data storage device (e.g., data storage system 110). In some non-limiting embodiments or aspects, synthetic data generation system 106 may be associated with a transaction service provider, as described herein. In some non-limiting embodiments or aspects, synthetic data request handling system 104 and synthetic data generation system 106 may be the same system and/or parts of the same system.

Machine learning model training system 108 may include one or more devices capable of receiving information from and/or communicating information to user device 102, synthetic data request handling system 104, synthetic data generation system 106, and/or data storage system 110 (e.g., directly via wired or wireless communication, indirectly, via a public and/or private communication network connection, and/or the like). For example, as shown in FIG. 1, machine learning model training system 108 may be in communication with synthetic data generation system 106 and/or data storage system 110. In some non-limiting embodiments or aspects, machine learning model training system 108 may include a computing device, such as server, a group of servers, a computer, a group of computers, and/or other like devices. In some non-limiting embodiments or aspects, machine learning model training system 108 may be in communication with a data storage device (e.g., data storage system 110), which may be local or remote to machine learning model training system 108. In some non-limiting embodiments or aspects, machine learning model training system 108 may be capable of receiving information from, storing information in, communicating information to, or searching information stored in the data storage device (e.g., data storage system 110). In some non-limiting embodiments or aspects, machine learning model training system 108 may be associated with a transaction service provider, as described herein. In some non-limiting embodiments or aspects, at least two of (e.g., all of) synthetic data request handling system 104, synthetic data generation system 106, and/or machine learning model training system 108 may be the same system and/or parts of the same system.

Data storage system 110 may include one or more devices capable of receiving information from and/or communicating information to user device 102, synthetic data request handling system 104, synthetic data generation system 106, and/or machine learning model training system 108 (e.g., directly via wired or wireless communication, indirectly, via a public and/or private communication network connection, and/or the like). For example, as shown in FIG. 1, data storage system 110 may be in communication with synthetic data request handling system 104, synthetic data generation system 106 and/or machine learning model training system 108. In some non-limiting embodiments or aspects, data storage system 110 may include a computing device, such as server, a group of servers, a computer, a group of computers, and/or other like devices. In some non-limiting embodiments or aspects, data storage system 110 may include and/or be in communication with a data storage device, which may be local or remote to machine data storage system 110. In some non-limiting embodiments or aspects, data storage system 110 may be capable of receiving information from, storing information in, communicating information to, or searching information stored in the data storage device. In some non-limiting embodiments or aspects, data storage system 110 may be associated with a transaction service provider, as described herein. In some non-limiting embodiments or aspects, at least two of (e.g., all of) synthetic data request handling system 104, synthetic data generation system 106, machine learning model training system 108, and/or data storage system 110 may be the same system and/or parts of the same system.

The systems and/or devices of FIG. 1 may communicate via one or more wired and/or wireless communication networks. For example, the communication network(s) may include a cellular network (e.g., a long-term evolution (LTE®) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

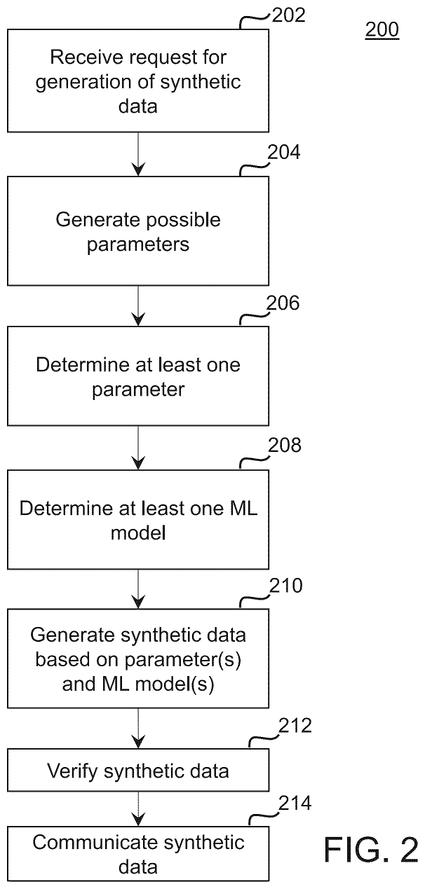

Referring now to FIG. 2, shown is a flow diagram for an example method 200 for privacy-preserving synthetic data generation, according to some non-limiting embodiments or aspects. The steps shown in FIG. 2 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. In some non-limiting embodiments or aspects, one or more of the steps of method 200 may be performed (e.g., completely, partially, and/or the like) by one or more of the devices and/or systems shown in FIG. 1. In some non-limiting embodiments or aspects, one or more of the steps of method 200 may be performed (e.g., completely, partially, and/or the like) by another system, another device, another group of systems, or another group of devices, separate from or including the devices and/or systems shown in FIG. 1.

As shown in FIG. 2, at step 202, method 200 may include receiving a request for generation of synthetic data. For example, synthetic data request handling system 104 may receive a request for generation of synthetic data (e.g., from user device 102).

As shown in FIG. 2, at step 204, method 200 may include generating possible parameters. For example, synthetic data request handling system 104 may generate a plurality of possible parameters for the synthetic data.

In some non-limiting embodiments or aspects, the plurality of possible parameters may include at least one of the following: an engine parameter associated with one or more of the plurality of machine learning models, an operational parameter, a file location parameter, an access parameter, a descriptive parameter associated with at least a portion of the real data, field grouping data associated with at least two fields of the real data, a privacy parameter, an output of a large language model, or any combination thereof.

In some non-limiting embodiments or aspects, the field grouping data may be based on a decision tree based on the at least two fields of the real data.

In some non-limiting embodiments or aspects, the output of the large language model may be associated with at least one recommended parameter based on at least one of the following: the real data, the at least one input from the user, or any combination thereof.

As shown in FIG. 2, at step 206, method 200 may include determining at least one parameter. For example, synthetic data request handling system 104 may determine at least one parameter based on the plurality of possible parameters and at least one input from the user (e.g., received from user device 102).

As shown in FIG. 2, at step 208, method 200 may include determining at least one machine learning model. For example, synthetic data generation system 106 may determine at least one machine learning model from a plurality of machine learning models based on the at least one parameter.

In some non-limiting embodiments or aspects, each machine learning model of the plurality of machine learning models may include at least one of a neural network, a deep neural network, a convolutional neural network (CNN), a recurrent neural network (RNN), an autoencoder (or portion thereof), a variational autoencoder (or portion thereof), a beta-variational autoencoder (β-VAE) (or portion thereof), a long short-term memory (LSTM), a bidirectional LSTM, an attention network, a transformer, a tree-based classifier, a random forest, a generative adversarial network (GAN) (or a portion thereof), a conditional GAN (CTGAN) (or a portion thereof), any combination thereof, and/or the like.

In some non-limiting embodiments or aspects, the plurality of machine learning models may be (e.g., may have been) trained (e.g., by machine learning model training system 108) based on real data.

In some non-limiting embodiments or aspects, training one of the machine learning models may include causing the machine learning model to generate experimental synthetic data. For example, based on the type of machine learning model, causing the machine learning model to generate experimental synthetic data may include inputting real data to the machine learning model to cause the machine learning model to generate a reconstruction of the real data. Additionally or alternatively, causing the machine learning model to generate experimental synthetic data may include inputting a random input to the machine learning model to cause the machine learning model to generate experimental synthetic data that has at least some similar characteristics to the real data (e.g., the output distribution of the experimental synthetic data may have at least some metrics associated therewith that are similar to the distribution of the real data). A loss may be determined based on the experimental synthetic data. For example, the loss may be associated with a difference between the real data and the experimental synthetic data or a difference between at least one metric associated with the real data (e.g., the distribution of the real data) and at least one corresponding metric associated with the experimental synthetic data (e.g., the output distribution of the experimental synthetic data). Additionally or alternatively, the loss may be associated with a re-identification risk of the experimental synthetic data. In some non-limiting embodiments or aspects, the loss may be calculated based on a loss function, an error, a mean error, a mean squared error (MSE), a cross-entropy loss, a log loss, a divergence (e.g., a Kullback-Leibler (KL) divergence), any combination thereof, and/or the like. The parameters of the machine learning model may be updated based on the loss. For example, the parameters of the machine learning model may be updated (e.g., adjusted) based on back propagation (e.g., of the loss(es)), gradient calculations (e.g., based on the loss(es)), any combination thereof, and/or the like.

In some non-limiting embodiments or aspects, each respective machine learning model of the plurality of machine learning models may be (e.g., may have been) trained (e.g., by machine learning model training system 108) based on a respective portion of the real data associated with a respective cluster of entities of a plurality of entities associated with the real data.

As shown in FIG. 2, at step 210, method 200 may include generating the synthetic data based on the parameter(s) and the machine learning model(s). For example, synthetic data generation system 106 may generate the synthetic data based on the at least one machine learning model and the at least one parameter.

As shown in FIG. 2, at step 212, method 200 may include verifying the synthetic data. For example, synthetic data generation system 106 may verify the synthetic data based on at least one of the at least one parameter, the real data, or any combination thereof.

In some non-limiting embodiments or aspects, at least one metric associated with the synthetic data and at least one metric associated with the real data may be determined. For example, verifying the synthetic data may include comparing the at least one metric associated with the synthetic data and the at least one metric associated with the real data.

In some non-limiting embodiments or aspects, a privacy re-identification risk associated with the synthetic data may be determined. For example, wherein verifying the synthetic data may be further based on the privacy re-identification risk.

In some non-limiting embodiments or aspects, at least one metric associated with the synthetic data may be determined. For example, wherein verifying the synthetic data may be based on the at least one metric associated with the synthetic data and the privacy re-identification risk.

As shown in FIG. 2, at step 214, method 200 may include communicating the synthetic data. For example, synthetic data request handling system 104 and/or synthetic data generation system 106 may communicate the synthetic data (e.g., to user device 102 and/or data storage system 110).

In some non-limiting embodiments or aspects, in response to verifying the synthetic data, the synthetic data may be communicated (e.g., by synthetic data request handling system 104 and/or synthetic data generation system 106) to the user (e.g., user device 102 of the user).

In some non-limiting embodiments or aspects, at least one other (e.g., downstream) machine learning model may be trained based on the synthetic data. For example, the other machine learning model(s) may include at least one of a fraud detection model, a risk detection model, a transaction authorization model, a credit approval model, a product recommendation model, a classifier model, an anomaly detection model, an authentication model, any combination thereof, and/or the like.

In some non-limiting embodiments or aspects, training the other (e.g., downstream) machine learning model may include inputting the synthetic data to the other machine learning model to generate a prediction. A loss may be determined based on the prediction. For example, the loss may be associated with a difference between the prediction and an expected prediction (e.g., that was generated as part of generating the synthetic data). In some non-limiting embodiments or aspects, the loss may be calculated based on a loss function, an error, a mean error, a mean squared error (MSE), a cross-entropy loss, a log loss, a divergence (e.g., a KL divergence), any combination thereof, and/or the like. The parameters of the other machine learning model may be updated based on the loss. For example, the parameters of the other machine learning model may be updated (e.g., adjusted) based on back propagation (e.g., of the loss(es)), gradient calculations (e.g., based on the loss(es)), any combination thereof, and/or the like.

In some non-limiting embodiments or aspects, a transaction message may be received (e.g., by a transaction processing system, as described herein). At least one action may be performed based on the transaction message and the other machine learning model(s) (e.g., that has been trained based on the synthetic data). For example, the other machine learning model(s) may include a fraud detection model. Performing the action(s) may include denying a transaction associated with the transaction message based on inputting the transaction message (or an input based on transaction message) to the fraud detection model (e.g., that has been trained based on the synthetic data). For example, the fraud detection model may generate a prediction that the transaction is fraudulent, and the transaction may be denied based on the prediction.

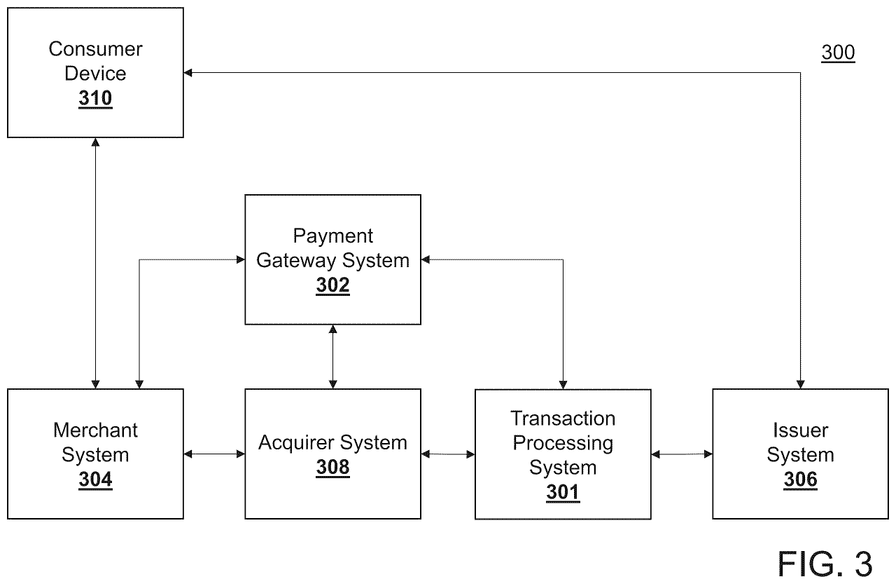

Referring now to FIG. 3, depicted is a diagram of an example payment processing network 300, according to non-limiting embodiments or aspects. In some non-limiting embodiments or aspects, payment processing network 300 may be used in conjunction with the systems, methods, and/or computer program products described herein, and/or the systems, methods, and/or computer program products described herein may be implemented in payment processing network 300. As shown in FIG. 3, payment processing network 300 may include transaction processing system 301, payment gateway system 302, merchant system 304, issuer system 306, acquirer system 308, and/or consumer device 310. In some non-limiting embodiments or aspects, each of user device 102, synthetic data request handling system 104, synthetic data generation system 106, machine learning model training system 108, and/or data storage system 110 of FIG. 1 may be implemented by (e.g., part of) transaction processing system 301. In some non-limiting embodiments or aspects, at least one of user device 102, synthetic data request handling system 104, synthetic data generation system 106, machine learning model training system 108, and/or data storage system 110 of FIG. 1 may be implemented by (e.g., part of) another system, another device, another group of systems, or another group of devices, separate from or including transaction processing system 301, such as merchant system 304, issuer system 306, acquirer system 308, consumer device 310, and/or the like. For example, user device 102 may be implemented by (e.g., part of) at least one of payment gateway system 302, merchant system 304, issuer system 306, acquirer system 308, and/or consumer device 310.

Transaction processing system 301 may include one or more devices capable of receiving information from and/or communicating information to payment gateway system 302, merchant system 304, issuer system 306, acquirer system 308, consumer device 310, and/or the like (e.g., directly, indirectly, via a public and/or private communication network connection, and/or the like). For example, as shown in FIG. 3, transaction processing system 301 may be in communication with one or more issuer systems (e.g., issuer system 306), one or more acquirer systems (e.g., acquirer system 308), and/or one or more payment gateway systems (e.g., payment gateway system 302). Although only a single issuer system 306, single acquirer system 308, and single payment gateway system 302 are shown, it will be appreciated that transaction processing system 301 may be in communication with a plurality of issuer systems, a plurality of acquirer systems, and/or a plurality of payment gateways. In some non-limiting embodiments or aspects, transaction processing system 301 may include a computing device, such as a server (e.g., a transaction processing server), a group of servers, and/or other like devices. In some non-limiting embodiments or aspects, transaction processing system 301 may be in communication with a data storage device, which may be local or remote to transaction processing system 301. In some non-limiting embodiments or aspects, transaction processing system 301 may be capable of receiving information from, storing information in, communicating information to, or searching information stored in the data storage device. In some non-limiting embodiments or aspects, transaction processing system 301 may be associated with a transaction service provider, as described herein. In some non-limiting embodiments or aspects, transaction processing system 301 may also operate as an issuer system such that both transaction processing system 301 and issuer system 306 are a single system and/or controlled by a single entity.

Payment gateway system 302 may include one or more devices capable of receiving information from and/or communicating information to transaction processing system 301, merchant system 304, issuer system 306, acquirer system 308, consumer device 310, and/or the like (e.g., directly, indirectly, via a public and/or private communication network connection, and/or the like). For example, as shown in FIG. 3, payment gateway system 302 may be in communication with one or more merchant systems (e.g., merchant system 304), one or more acquirer systems (e.g., acquirer system 308), and/or one or more transaction processing systems (e.g., transaction processing system 301). Although only a single merchant system 304, single acquirer system 308, and single transaction processing system 301 are shown, it will be appreciated that payment gateway system 302 may be in communication with a plurality of merchant systems, a plurality of acquirer systems, and/or a plurality of transaction processing systems. In some non-limiting embodiments or aspects, payment gateway system 302 may include a computing device, such as a server, a group of servers, and/or other like devices. In some non-limiting embodiments or aspects, payment gateway system 302 may be associated with a payment gateway, as described herein.

Merchant system 304 may include one or more devices capable of receiving information from and/or communicating information to transaction processing system 301, payment gateway system 302, issuer system 306, acquirer system 308, consumer device 310, and/or the like (e.g., directly, indirectly, via a public and/or private communication network connection, and/or the like). For example, as shown in FIG. 3, merchant system 304 may be in communication with one or more payment gateway systems (e.g., payment gateway system 302), one or more acquirer systems (e.g., acquirer system 308), and/or one or more consumer devices (e.g., consumer device 310). Although only a single payment gateway system 302, single acquirer system 308, and single consumer device 310 are shown, it will be appreciated that merchant system 304 may be in communication with a plurality of payment gateway systems, a plurality of acquirer systems, and/or a plurality of consumer devices. In some non-limiting embodiments or aspects, merchant system 304 may include a computing device, such as a server, a group of servers, a client device, a group of client devices, a POS device, a POS system, computers, computer systems, peripheral devices, and/or other like devices. In some non-limiting embodiments or aspects, merchant system 304 may be associated with a merchant, as described herein. In some non-limiting embodiments or aspects, merchant system 304 may include a device capable of receiving information from and/or communicating information to consumer device 310 via a short-range communication connection (e.g., an NFC communication connection, an RFID communication connection, a Bluetooth® communication connection, a Zigbee® communication connection, and/or the like) with consumer device 310 and/or the like. In some non-limiting embodiments or aspects, merchant system 304 may include one or more client devices. For example, merchant system 304 may include a client device that allows a merchant to communicate information to transaction processing system 301 (e.g., via at least one of acquirer system 308 and/or payment gateway system 302). In some non-limiting embodiments or aspects, merchant system 304 (e.g., a client device thereof, a POS device thereof, and/or the like) may also operate as a payment gateway system such that both merchant system 304 and payment gateway system 302 are a single system and/or controlled by a single entity.

Issuer system 306 may include one or more devices capable of receiving information and/or communicating information to transaction processing system 301, payment gateway system 302, merchant system 304, acquirer system 308, consumer device 310, and/or the like (e.g., directly, indirectly, via a public and/or private communication network connection, and/or the like). For example, as shown in FIG. 3, issuer system 306 may be in communication with one or more transaction processing systems (e.g., transaction processing system 301) and/or one or more consumer devices (e.g., consumer device 310). Although only a single transaction processing system 301 and a single consumer device 310 are shown, it will be appreciated that issuer system 306 may be in communication with a plurality of transaction processing systems and/or a plurality of consumer devices 310. In some non-limiting embodiments or aspects, issuer system 306 may include a computing device, such as a server, a group of servers, and/or other like devices. In some non-limiting embodiments or aspects, issuer system 306 may be associated with an issuer institution, as described herein. For example, issuer system 306 may be associated with an issuer institution that issued a credit account, a debit account, a credit card, a debit card, a payment device, and/or the like to a user associated with consumer device 310.

Acquirer system 308 may include one or more devices capable of receiving information from and/or communicating information to transaction processing system 301, payment gateway system 302, merchant system 304, issuer system 306, consumer device 310, and/or the like (e.g., directly, indirectly, via a public and/or private communication network connection, and/or the like). For example, as shown in FIG. 3, acquirer system 308 may be in communication with one or more transaction processing systems (e.g., transaction processing system 301), one or more payment gateway systems (e.g., payment gateway system 302), and/or one or more merchant systems (e.g., merchant system 304). Although only a single transaction processing system 301, a single payment gateway system 302, and a single merchant system 304 are shown, it will be appreciated that acquirer system 308 may be in communication with a plurality of transaction processing systems, a plurality of payment gateway systems, and/or a plurality of merchant systems. In some non-limiting embodiments or aspects, acquirer system 308 may include a computing device, such as a server, a group of servers, and/or other like devices. In some non-limiting embodiments or aspects, acquirer system 308 may be associated with an acquirer institution, as described herein.

Consumer device 310 may include one or more devices capable of receiving information from and/or communicating information to transaction processing system 301, payment gateway system 302, merchant system 304, issuer system 306, acquirer system 308, and/or the like (e.g., directly, indirectly, via a public and/or private communication network connection, and/or the like). For example, as shown in FIG. 3, consumer device 310 may be in communication with one or more merchant systems (e.g., merchant system 304) and/or one or more issuer systems (e.g., issuer system 306). Although only a single merchant system 304 and a single issuer system 306 are shown, it will be appreciated that consumer device 310 may be in communication with a plurality of merchant systems and/or a plurality of issuer systems. In some non-limiting embodiments or aspects, consumer device 310 may be associated with a user to whom a credit account, a debit account, a credit card, a debit card, a payment device, and/or the like has been issued. In some non-limiting embodiments or aspects, consumer device 310 may include a computing device, such as a computer, a portable computer, a laptop computer, a tablet computer, a mobile device, a cellular phone, a smartphone, a wearable device (e.g., watches, glasses, lenses, clothing, and/or the like), a PDA, a client device, and/or other like devices. In some non-limiting embodiments or aspects, consumer device 310 may include a payment device, as described herein. In some non-limiting embodiments or aspects, consumer device 310 may include a device capable of receiving information from and/or communicating information to other consumer devices 310 (e.g., directly, indirectly, via a public and/or private communication network connection, a short-range communication connection, and/or the like). In some non-limiting embodiments or aspects, consumer device 310 may include a device capable of receiving information from and/or communicating information to merchant system 304 via a short-range communication connection (e.g., an NFC communication connection, an RFID communication connection, a Bluetooth® communication connection, a Zigbee® communication connection, and/or the like) with merchant system 304 and/or the like. In some non-limiting embodiments or aspects, consumer device 310 may include a client device.

In some non-limiting embodiments or aspects, transaction processing system 301 may communicate with merchant system 304 directly (e.g., via a public and/or private communication network connection and/or the like). Additionally or alternatively, transaction processing system 301 may communicate with merchant system 304 through payment gateway 302 and/or acquirer system 308. In some non-limiting embodiments or aspects, acquirer system 308 associated with merchant system 304 may operate as payment gateway system 302 to facilitate the communication of transaction messages (e.g., authorization requests) from merchant system 304 to transaction processing system 301. In some non-limiting embodiments or aspects, merchant system 304 may communicate with payment gateway system 302 directly (e.g., via a public and/or private communication network connection and/or the like). For example, merchant system 304, that includes a physical POS device, may communicate with payment gateway system 302 through a public or private network to conduct card-present transactions. As another example, merchant system 304, that includes a server (e.g., a web server), may communicate with payment gateway system 302 through a public or private network, such as the Internet, to conduct card-not-present transactions.

For the purpose of illustration, processing a transaction (e.g., a payment transaction) may include generating a transaction message (e.g., authorization request and/or the like) based on an account identifier of a customer (e.g., accountholder associated with consumer device 310 and/or the like) and/or transaction data associated with the transaction. For example, merchant system 304 (e.g., a client device of merchant system 304, a POS device of merchant system 304, and/or the like) may initiate the transaction, e.g., by generating an authorization request (e.g., in response to receiving the account identifier from a payment device and/or a portable financial device of the customer and/or the like). Merchant system 304 may communicate the authorization request to payment gateway system 302 and/or acquirer system 308. In some non-limiting embodiments or aspects, payment gateway system 302 may communicate the authorization request to acquirer system 308 and/or transaction processing system 301. Additionally or alternatively, acquirer system 308 (and/or payment gateway system 302) may communicate the authorization request to transaction processing system 301. After receiving the authorization request from merchant system 304 that identifies the account identifier of the customer (e.g., the accountholder associated with consumer device 310 and/or the account identifier), transaction processing system 301 may communicate the authorization request to issuer system 306 (e.g., the issuer system that issued the payment device and/or account identifier). Issuer system 306 may determine an authorization decision (e.g., approve, deny, and/or the like) based on the authorization request, and/or issuer system 306 may generate an authorization response based on the authorization decision and/or the authorization request. Issuer system 306 may communicate the authorization response to transaction processing system 301. Transaction processing system 301 may communicate the authorization response to acquirer system 308 and/or payment gateway system 302. In some non-limiting embodiments or aspects, acquirer system 308 may communicate the authorization response to payment gateway system 302 and/or merchant system 304. Additionally or alternatively, payment gateway system 302 (and/or acquirer system 308) may communicate the authorization response to merchant system 304.

In some non-limiting embodiments or aspects, transaction processing system 301 and/or issuer system 306 may include at least one machine learning model (e.g., at least one of a fraud detection model, a risk detection model, a transaction authorization model, a credit approval model, a product recommendation model, a classifier model, an anomaly detection model, an authentication model, any combination thereof, and/or the like). For example, the machine learning model(s) may be trained based on synthetic data generated, as described herein. Transaction processing system 301 and/or issuer system 306 may perform at least one task (e.g., generate a prediction and/or generate an embedding) based on the authorization request and the machine learning model(s). For example, performing the task(s) may include generating at least one prediction associated with fraud detection, risk detection, transaction authorization, credit approval, product recommendation, classification, anomaly detection, authentication, any combination thereof, and/or the like. In some non-limiting embodiments or aspects, transaction processing system 301 may communicate at least one message based on performing the task (e.g., generating the prediction and/or generate an embedding) to issuer system 306 (e.g., along with the authorization request). In some non-limiting embodiments or aspects, issuer system 306 may determine the authorization decision (e.g., approve, deny, and/or the like) based on the authorization request and the performance of the task (e.g., generation of the prediction and/or generation of the embedding).

For the purpose of illustration, clearing and/or settlement of a transaction may include generating a message (e.g., clearing message and/or the like) based on an account identifier of a customer (e.g., associated with consumer device 310 and/or the like) and/or transaction data associated with the transaction. For example, merchant system 304 may generate at least one clearing message (e.g., a plurality of clearing messages, a batch of clearing messages, and/or the like). Merchant system 304 may communicate the clearing message(s) to acquirer system 308 (and/or payment gateway system 302, which may communicate the clearing message(s) to acquirer system 308). Acquirer system 308 may communicate the clearing message(s) to transaction processing system 301. Transaction processing system 301 may communicate the clearing message(s) to issuer system 306. Issuer system 306 may generate at least one settlement message based on the clearing message(s). In some non-limiting embodiments or aspects, issuer system 306 may communicate the settlement message(s) and/or funds to transaction processing system 301 (and/or a settlement bank system associated with transaction processing system 301), and transaction processing system 301 (and/or the settlement bank system) may communicate the settlement message(s) and/or funds to acquirer system 308. Additionally or alternatively, issuer system 306 may communicate the settlement message(s) and/or funds to acquirer system 308. In some non-limiting embodiments or aspects, acquirer system 308 may communicate the settlement message(s) and/or funds to merchant system 304 (and/or an account associated with merchant system 304).

The systems and/or devices of FIG. 3 may communicate via one or more wired and/or wireless communication networks. For example, the communication network(s) may include a cellular network (e.g., a long-term evolution (LTE®) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 3 are provided as an example. There may be additional systems, devices, and/or networks; fewer systems, devices, and/or networks; different systems, devices, and/or networks; and/or differently arranged systems, devices, and/or networks than those shown in FIG. 3. Furthermore, two or more systems or devices shown in FIG. 3 may be implemented within a single system or device, or a single system or device shown in FIG. 3 may be implemented as multiple, distributed systems or devices. Additionally or alternatively, a set of systems (e.g., one or more systems) or a set of devices (e.g., one or more devices) of payment processing network 300 may perform one or more functions described as being performed by another set of systems or another set of devices of payment processing network 300.

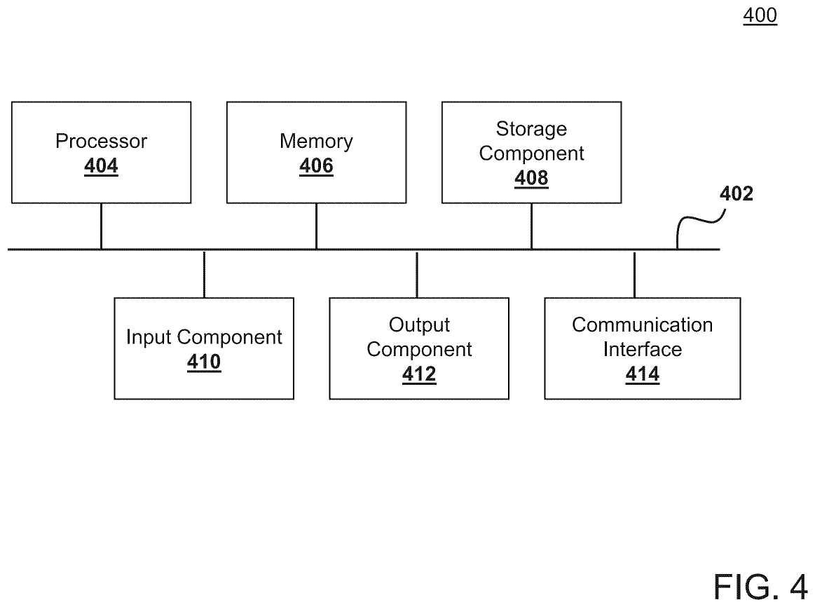

Referring now to FIG. 4, shown is a diagram of example components of device 400, according to non-limiting embodiments or aspects. Device 400 may correspond to user device 102, synthetic data request handling system 104, synthetic data generation system 106, machine learning model training system 108, and/or data storage system 110 of FIG. 1 and/or transaction processing system 301, payment gateway system 302, merchant system 304, issuer system 306, acquirer system 308, and/or consumer device 310 of FIG. 3, as an example. In some non-limiting embodiments or aspects, such systems or devices may include at least one device 400 and/or at least one component of device 400. The number and arrangement of components shown are provided as an example. In some non-limiting embodiments or aspects, device 400 may include additional components, fewer components, different components, or differently arranged components than those shown. Additionally or alternatively, a set of components (e.g., one or more components) of device 400 may perform one or more functions described as being performed by another set of components of device 400.

As shown in FIG. 4, device 400 may include bus 402, processor 404, memory 406, storage component 408, input component 410, output component 412, and communication interface 414. Bus 402 may include a component that permits communication among the components of device 400. In some non-limiting embodiments, processor 404 may be implemented in hardware, firmware, or a combination of hardware and software. For example, processor 404 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 406 may include random access memory (RAM), read only memory (ROM), and/or another type of dynamic or static storage device (e.g., flash memory, magnetic memory, optical memory, etc.) that stores information and/or instructions for use by processor 404.

With continued reference to FIG. 4, storage component 408 may store information and/or software related to the operation and use of device 400. For example, storage component 408 may include a hard disk (e.g., a magnetic disk, an optical disk, a magneto-optic disk, a solid-state disk, etc.) and/or another type of computer-readable medium. Input component 410 may include a component that permits device 400 to receive information, such as via user input (e.g., a touch screen display, a keyboard, a keypad, a mouse, a button, a switch, a microphone, etc.). Additionally or alternatively, input component 410 may include a sensor for sensing information (e.g., a global positioning system (GPS) component, an accelerometer, a gyroscope, an actuator, etc.). Output component 412 may include a component that provides output information from device 400 (e.g., a display, a speaker, one or more light-emitting diodes (LEDs), etc.). Communication interface 414 may include a transceiver-like component (e.g., a transceiver, a separate receiver and transmitter, etc.) that enables device 400 to communicate with other devices, such as via a wired connection, a wireless connection, or a combination of wired and wireless connections. Communication interface 414 may permit device 400 to receive information from another device and/or provide information to another device. For example, communication interface 414 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 400 may perform one or more processes described herein. Device 400 may perform these processes based on processor 404 executing software instructions stored by a computer-readable medium, such as memory 406 and/or storage component 408. A computer-readable medium may include any non-transitory memory device. A memory device includes memory space located inside of a single physical storage device or memory space spread across multiple physical storage devices. Software instructions may be read into memory 406 and/or storage component 408 from another computer-readable medium or from another device via communication interface 414. When executed, software instructions stored in memory 406 and/or storage component 408 may cause processor 404 to perform one or more processes described herein. Additionally or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

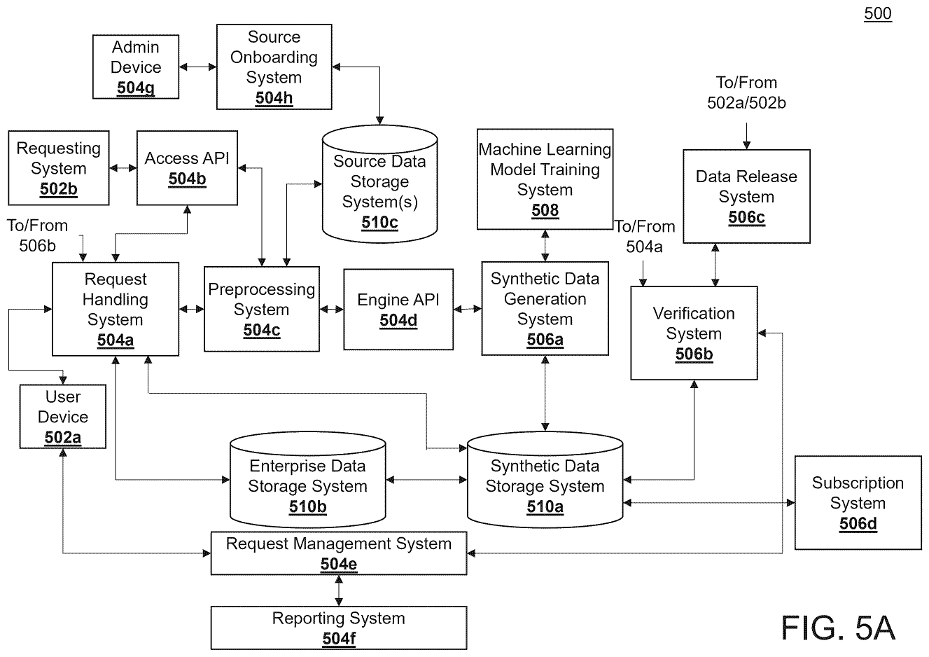

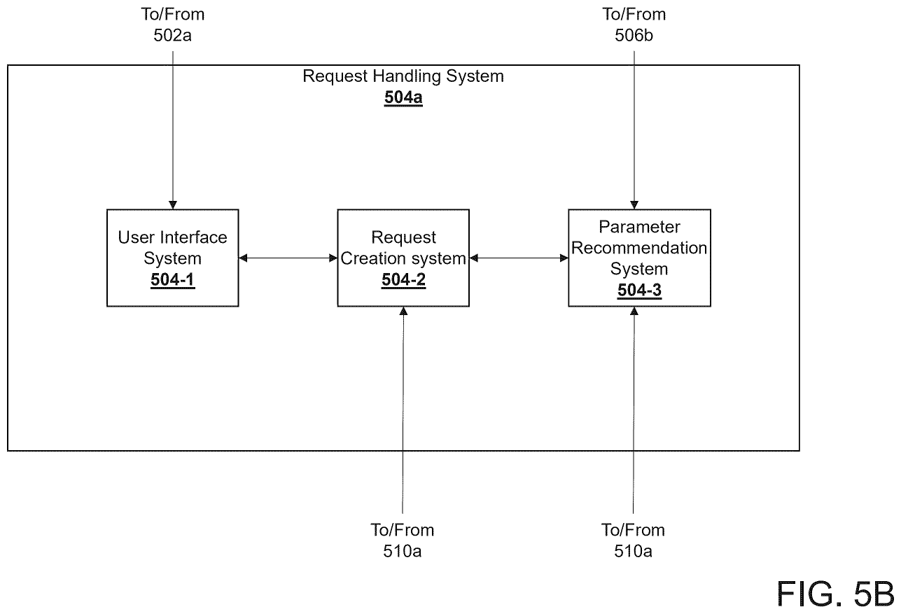

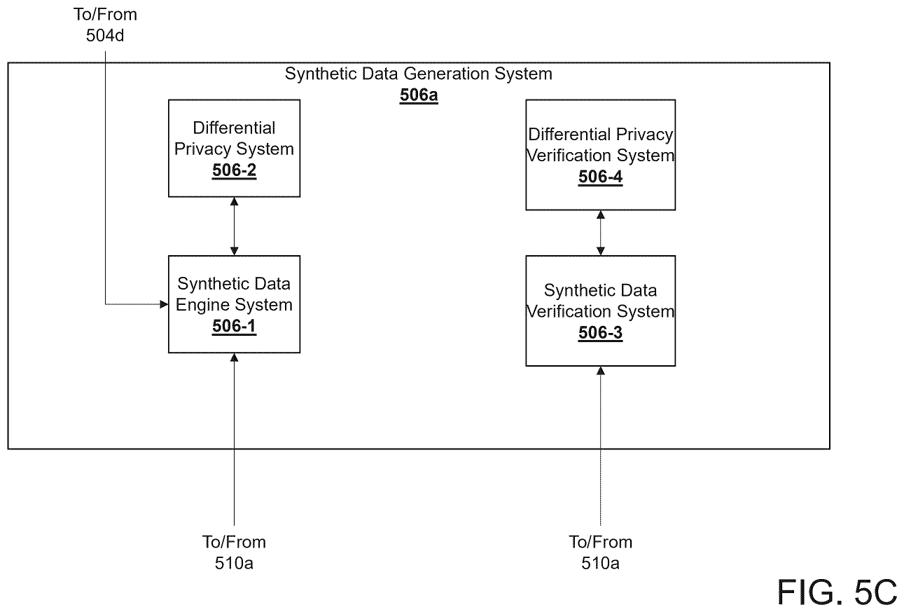

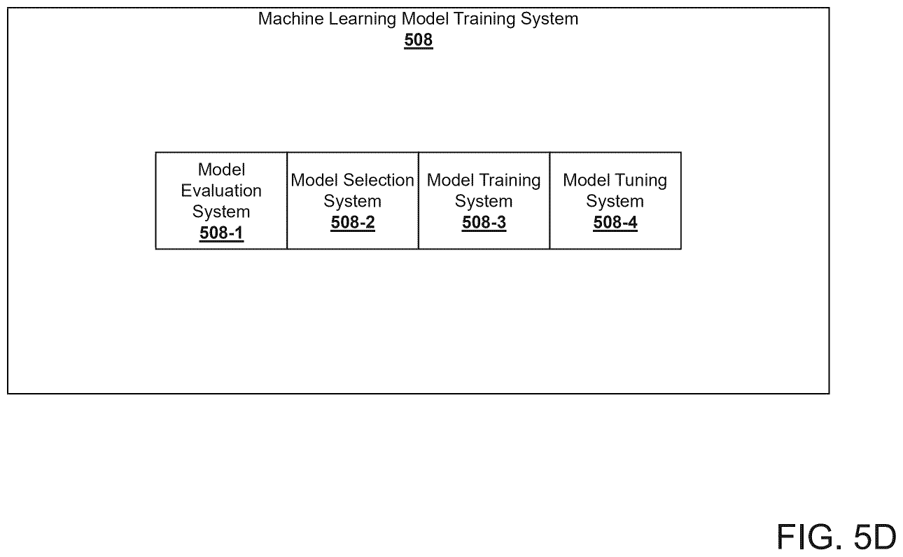

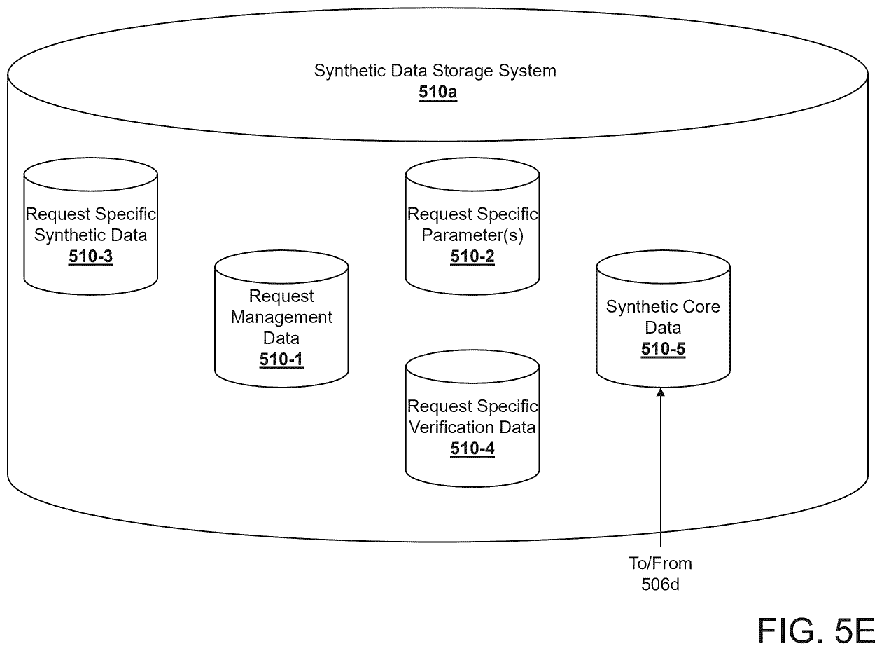

Referring now to FIGS. 5A-5E, shown are schematic diagrams of an example system 500 for privacy-preserving synthetic data generation, according to some non-limiting embodiments or aspects. In some non-limiting embodiments or aspects, system 500 may be the same as or similar to system 100. For example, in some non-limiting embodiments or aspects, user device 502a and/or requesting system 502b may be the same as, similar to, or part of user device 102. In some non-limiting embodiments or aspects, request handling system 504a, access application programming interface (API) 504b, preprocessing system 504c, engine API 504d, request management system 504e, reporting system 504f, admin device 504g, and/or source onboarding system 504h may be the same as, similar to, or part of synthetic data request handling system 104. In some non-limiting embodiments or aspects, synthetic data generation system 506a, verification system 506b, data release system 506c, and/or subscription system 506d may be the same as, similar to, or part of synthetic data generation system 106. In some non-limiting embodiments or aspects, machine learning model training system 508 may be the same as, similar to, or part of machine learning model training system 108. In some non-limiting embodiments or aspects, synthetic data storage system 510a, enterprise data storage system 510b, and/or source data storage systems 510c may be the same as, similar to, or part of data storage system 110. In some non-limiting embodiments or aspects, the processes performed by system 500 may be the same as or similar to method 200. The number and arrangement of systems, devices, and/or components shown in FIGS. 5A-5E are provided as an example. There may be additional systems, devices, and/or components; fewer systems, devices, and/or components; different systems, devices, and/or components; and/or differently arranged systems, devices, and/or components than those shown in FIGS. 5A-5E. Furthermore, two or more systems or devices shown in FIGS. 5A-5E may be implemented within a single system or device, or a single system or device shown in FIGS. 5A-5E may be implemented as multiple, distributed systems or devices. Additionally or alternatively, a set of systems (e.g., one or more systems) or a set of devices (e.g., one or more devices) of system 500 may perform one or more functions described as being performed by another set of systems or another set of devices of system 500.

In some non-limiting embodiments or aspects, request handling system 504a may receive a request for generation of synthetic data from user device 502a. For example, a user may use user device 502a to access a user interface (e.g., graphical user interface (GUI)) hosted by user interface system 504-1 of request handling system 504a to communicate a request to request handling system 504a. In some non-limiting embodiments or aspects, the user interface may be a web-based user interface, which may be accessible via a web browser of user device 502a. In some non-limiting embodiments or aspects, the user interface may be part of an app (e.g., a software application, a mobile application, and/or the like) configured to communicate with user interface system 504-1 of request handling system 504a (e.g., via an API and/or the like). In some non-limiting embodiments or aspects, the user may authenticate (e.g., log in) via user device 502 before accessing the user interface. For example, the user may use a username and password, a passkey, a single sign-on authentication, and/or the like.

In some non-limiting embodiments or aspects, request handling system 504a (e.g., request creation system 504-2 thereof) may generate a request data structure based on receiving the request. For example, request creation system 504-2 may generate a request identifier (e.g., request ID), which may be used as a key (e.g., index) for the request data structure. The request data structure may include other information (e.g., data, metadata, and/or the like) about the request. For example, the other data may include user identification data (e.g., based on the authentication), submission time data, submission date data, input data (e.g., data that was inputted into the user interface by the user of user device 502a), any combination thereof, and/or the like.

In some non-limiting embodiments or aspects, all information related to the request (e.g., the request data structure) may be captured (e.g., stored) in synthetic data storage system 510a (e.g., request management data 510-1 of synthetic data storage system 510a).

In some non-limiting embodiments or aspects, request handling system 504a (e.g., parameter recommendation system 504-3) may generate a plurality of possible parameters for the synthetic data. For example, the plurality of possible parameters may include at least one of the following: an engine parameter associated with one or more of the plurality of machine learning models, a recommended selection of at least one of the plurality of models, an operational parameter, a file location parameter, an access parameter, a descriptive parameter associated with at least a portion of the real data, field data (e.g., what fields to include in the request), filter criteria (e.g., what fields to use as a filter), field grouping data associated with at least two fields of the real data (e.g., standard field grouping, default field grouping, recommended field grouping, non-standard field grouping, and/or the like), a privacy parameter, an output type (e.g., a table, a file structure, a spreadsheet, text, an object (e.g., JSON), and/or the like), an output of an LLM, any combination thereof, and/or the like.

In some non-limiting embodiments or aspects, at least some of the possible parameters may be generated by artificial intelligence (e.g., generative artificial intelligence). For example, an LLM may generate at least some possible parameters. For example, the LLM may generate as an output at least one recommended parameter based on at least one of the following: the real data (e.g., actual transaction data), at least one input from the user (e.g., received from user device 502a via user interface system 504-1), or any combination thereof.

In some non-limiting embodiments or aspects, the LLM may be part of a chatbot (e.g., accessible to user device 502a via user interface system 504-1). In some non-limiting embodiments or aspects, the chatbot may ask at least one standard question to start a chat session with the user of user device 502a. The chatbot may use the LLM to generate additional questions based on inputs (e.g., responses, prompts, and/or the like) received from the user (e.g., via user device 502a). In some non-limiting embodiments or aspects, the LLM may proactively complete answers to some questions (e.g., some of the standard questions) based on inputs from the user (e.g., responses to other questions, prompts, and/or the like) without transmitting such questions to the user. In some non-limiting embodiments or aspects, the chatbot may use the LLM to generate the recommended parameter(s). In some non-limiting embodiments or aspects, the user may provide an input (e.g., via user device 502a) indicating selection of the recommended parameter(s) as the parameter(s) for the request for synthetic data generation.

In some non-limiting embodiments or aspects, at least some of the possible parameters may be generated based on capabilities of at least one machine learning model (e.g., a pre-trained model available from machine learning model training system 508). For example, as new machine learning models become available from machine learning model training system 508 (e.g., after such models are trained and/or validated by machine learning model training system 508), new parameters associated with the capabilities of such new machine learning models may be available as possible parameters.

In some non-limiting embodiments or aspects, request handling system 504a (e.g., parameter recommendation system 504-3) may capture additional information related to the possible parameters, such as file location (e.g., location of files associated with data from source data storage system(s) 510c, which may include real data), access parameters, field groupings, a selection of at least one engine (e.g., at least one machine learning model from a plurality of machine learning models available from machine learning model training system 508), parameters for the selected engine(s) (e.g., parameters for the selected machine learning model(s)), differential privacy information (e.g., user input parameters regarding differential privacy, an indication of whether differential privacy is needed and/or requested, and/or the like), data regarding at least one statistical tool (e.g., a call out to a statistical profiling tool), output parameters (e.g., transport, location, format, and/or the like), the desired size of the output (e.g., number of rows, data records, objects, and/or the like), geographic data, demographic data, any combination thereof, and/or the like.

In some non-limiting embodiments or aspects, the field grouping data may be based on a decision tree. For example, the decision tree may be based on at least two fields of real data.

In some non-limiting embodiments or aspects, the field grouping data may be hierarchical. For example, country, state, city, and postal code (e.g., zip code) may be fields of a hierarchical field grouping. The field grouping may prevent generation of synthetic data with a state outside of the country, a city outside of the state (and/or country), a postal code outside of the city (and/or state and/or country), any combination thereof, and/or the like. For example, the field grouping may indicate that the state must be within the country, the city must be within the state, the postal code must be inside of the city, any combination thereof, and/or the like.

In some non-limiting embodiments or aspects, the field grouping data may be based on patterns observed during training (and/or finetuning) of a machine learning model. For example, if it is observed that fields are correlated and/or otherwise related during training, field grouping data indicating the correlation and/or relationship may be generated (e.g., automatically generated by machine learning model training system 508 and/or the like).

In some non-limiting embodiments or aspects, the field grouping data may be based on relationships between fields. For example, if multiple fields are related to the same entity, field grouping data may be generated indicating the association of those fields with the entity. For the purpose of illustration, if a field grouping is based on an entity (e.g., a merchant), the fields in the field grouping may be the name of the entity (e.g., merchant name), the country code of the entity (e.g., merchant country code), the state code of the entity (e.g., merchant state code), the city of the entity (e.g., merchant city), any combination thereof, and/or the like. For another illustration, if a field grouping is based on a banking entity (e.g., an issuer), the fields in the field grouping may be the country code (e.g., issuer country), the region code (e.g., issuer region code), the business identifier of the entity (e.g., issuer business identifier), any combination thereof, and/or the like.

In some non-limiting embodiments or aspects, at least some field groupings may be set by default. Additionally or alternatively, at least some field groupings may be generated based on inputs from users (e.g., the user who requested generation of synthetic data, an administrative user, an expert, a researcher, a model developer, and/or the like). Additionally or alternatively, at least some field groupings may be automatically generated based on patterns observed during training of at least one machine learning model.

In some non-limiting embodiments or aspects, at least one parameter may be determined based on the plurality of possible parameters and at least one input from the user. For example, user device 502a may receive the input(s) (e.g., selections of parameters and/or the like) from the user, and user device 502a may communicate the inputs to request handling system 504a (e.g., user interface system 504-1 thereof).

In some non-limiting embodiments or aspects, all information related to the parameter(s) of the request may be captured (e.g., stored) in synthetic data storage system 510a (e.g., request specific parameter(s) 510-2 of synthetic data storage system 510a).

In some non-limiting embodiments or aspects, preprocessing system 504c may be configured to pre-process data from source data storage system(s) 510c. For example, preprocessing system 504c may be configured to pre-process data from source data storage system(s) 510c to make such data suitable for inputting into the selected engine/machine learning model from machine learning model training system 508.

In some non-limiting embodiments or aspects, preprocessing system 504c may be configured to pull (e.g., obtain, receive, retrieve, and/or the like) data from source data storage system(s) 510c. For example, preprocessing system 504c may use structured query language (SQL)-like commands to pull data from source data storage system(s) 510c.

For the purpose of illustration, preprocessing system 504c may pull specific columns (e.g., SELECT command), created metrics (e.g., SELECT command), filtered records (e.g., WHERE command), from different registered sources (e.g., FROM command). In some non-limiting embodiments or aspects, data sources in source data storage system(s) 510c may be onboarded (e.g., registered) via source onboarding system 504h. For example, onboarding system 504h may onboard the data sources in source data storage system(s) 510c based on inputs from a user (e.g., administrator user) of admin device 504g.

In some non-limiting embodiments or aspects, preprocessing system 504c may read the real data from source data storage system(s) 510c. Preprocessing system 504c may filter the real data (e.g., to remove unnecessary or low quality data). Preprocessing system 504c may sample the real data (e.g., sample a cluster of the real data, as described herein, sample a subset (e.g., random subset) of the data, and/or the like). Preprocessing system 504c may clean and/or normalize the data (e.g., to ensure the data is sufficiently high quality, to ensure that the selected fields (e.g., from the selected columns) are suitable for inputting to the machine learning model(s), and/or the like). Preprocessing system 504c may obfuscate and/or remove PII from the data. For example, preprocessing system 504c may scramble PII, encrypt PII, or remove PII from the data. Preprocessing system 504c may cluster the data. For example, cluster the data based on geography, demographics, fields that are relevant to the request for generation of synthetic data, and/or the like. In some non-limiting embodiments or aspects, clustering may improve training because different machine learning models may be trained based on different clusters. Additionally or alternatively, the clusters can be distributed to different nodes (e.g., physically or logically separate computing devices) to allow for parallel processing. In some non-limiting embodiments or aspects, preprocessing system 504c and/or the nodes thereof may include any suitable processor (e.g., a CPU and/or the like).

In some non-limiting embodiments or aspects, preprocessing system 504c may determine that the data (e.g., real data) from source data storage system(s) 510c is of a suitable type (e.g., based on the machine learning model, the parameter(s) of the request for generation of synthetic data, and/or the like). If necessary, preprocessing system 504c may convert the format of at least a portion of the data to ensure it is of the proper type and format (e.g., based on the machine learning model, the parameter(s) of the request, and/or the like).

In some non-limiting embodiments or aspects, admin device 504g may include a user interface for an administrator user. For example, the user interface may allow the administrator user of admin device 504g to onboard sources via source onboarding system 504h. In some non-limiting embodiments or aspects, admin device 504g (e.g., the user interface device thereof) may allow the administrator user to perform other administrative tasks. For example, an administrative task may include access management (e.g., role-based access management for each user, user device 502a, requesting system 502b, receivers of reports from reporting system 504f, and/or the like). Role-based access management may ensure that only authorized users (e.g., of user device 502a) or requesting systems 502b may access system 500 and/or may make requests for synthetic data generation. Other possible tasks may include statistical profiling (e.g., of data sources), PII scanning (e.g., of data sources and/or of generated synthetic data), and/or the like.

In some non-limiting embodiments or aspects, onboarding system 504h may onboard (e.g., register) data sources in source data storage system(s) 510c. For example, once a data source is onboarded, the data from that data source may be accessible to preprocessing system 504c. In some non-limiting embodiments or aspects, onboarding may include capturing attributes of the data set of each data source, such as physical location (e.g., where the data is stored in a data storage system, such as a server and/or the like), statistical profiling of the dataset (e.g., metrics of the real data, as described herein), schema of the dataset, grouping of fields of the dataset (e.g., hierarchical groupings of at least some fields in the dataset, dependencies between at least some fields in the dataset, and/or the like).

In some non-limiting embodiments or aspects, the data from source data storage system(s) 510c may not be stored in synthetic data storage system 510a. For example, this may prevent real data from source data storage system(s) 510c from being combined with or confused for synthetic data in synthetic data storage system 510a.

In some non-limiting embodiments or aspects, the request data structure (e.g., from request handling system 504a), the parameter(s), the preprocessed data from preprocessing system 504c, any combination thereof, and/or the like may be communicated to synthetic data generation system 506a via engine API 504d.

In some non-limiting embodiments or aspects, synthetic data generation system 506a (e.g., synthetic data engine system 506-1 thereof) may receive the communication (e.g., including the parameter(s) and/or the like) from engine API 504d. Based on the communication, synthetic data generation system 506a (e.g., synthetic data engine system 506-1 thereof) may determine (e.g., select) at least one machine learning model (e.g., synthetic data generation engine) from the plurality of machine learning models (e.g., synthetic data generation engines) available from machine learning model training system 508. For example, synthetic data engine system 506-1 may select the machine learning model based on the parameter(s) of the request.

In some non-limiting embodiments or aspects, the plurality of machine learning models may have been previously trained by machine learning model training system 508, as described herein.

In some non-limiting embodiments or aspects, some of the machine learning models may have been trained based on a respective portion of the real data associated with a respective cluster of entities of a plurality of entities associated with the real data. For example, a cluster may be a geographic cluster, a demographic cluster, any combination thereof, and/or the like. For the purpose of illustration, if one of the parameter(s) for the request for synthetic data is a particular geographic area and/or a particular demographic group, then a model trained based on a cluster associated with that geographic area and/or demographic group may be more useful (e.g., more accurate) for generating synthetic data from that particular request. As such, if one of the machine learning models available from machine learning model training system 508 was trained based on such a cluster that aligns with (e.g., matches) the parameter(s) for the request for synthetic data, synthetic data generation system 506a (e.g., synthetic data engine system 506-1 thereof) may select that machine learning model trained based on that cluster.

In some non-limiting embodiments or aspects, synthetic data generation system 506a (e.g., synthetic data engine system 506-1 thereof) may generate the synthetic data based on the at least one machine learning model and the at least one parameter. For example, synthetic data engine system 506-1 may use the selected machine learning model(s) (e.g., synthetic data generation engine(s)) to generate synthetic data in accordance with the parameter(s) from the request for synthetic data.

In some non-limiting embodiments or aspects, if differential privacy is needed and/or requested for the request for synthetic data, synthetic data generation system 506a may generate the synthetic data based on synthetic data engine system 506-1 (e.g., the selected machine learning model(s)) and differential privacy system 506-2 (e.g., a differential privacy library, which may ensure that the synthetic data generated by synthetic data engine system 506-1 is in accordance with the differential privacy parameter(s) from the request for synthetic data).

In some non-limiting embodiments or aspects, all information related to the synthetic data generated by synthetic data generation system 506a (e.g., synthetic data engine system 506-1 thereof) may be captured (e.g., stored) in synthetic data storage system 510a (e.g., request specific synthetic data 510-3 of synthetic data storage system 510a).

In some non-limiting embodiments or aspects, synthetic data verification system 506-3 may verify the synthetic data. For example, synthetic data verification system 506-3 may verify the synthetic data based on at least one of: the at least one parameter (e.g., from the request for synthetic data), the real data, any combination thereof, and/or the like. For the purpose of illustration, synthetic data verification system 506-3 may verify that the synthetic data is in accordance with (e.g., matches and/or the like) the parameter(s) from the request for synthetic data. Additionally or alternatively, synthetic data verification system 506-3 may verify that the synthetic data is in accordance with certain metrics (e.g., default metrics), such as data quality metrics (e.g., default data quality metrics, request-specific data quality metrics, and/or the like), privacy metrics (e.g., default privacy metrics, differential privacy metrics, and/or the like), any combination thereof, and/or the like.

In some non-limiting embodiments or aspects, synthetic data verification system 506-3 may determine at least one metric associated with the synthetic data and at least one metric associated with the real data. Verifying the synthetic data may include comparing the at least one metric associated with the synthetic data and the at least one metric associated with the real data. For example, the metric(s) may include shape of the data (e.g., shape of the synthetic data compared to shape of the real data), cardinality of the data (e.g., cardinality of the synthetic data compared to cardinality of the real data), schema of the data (e.g., schema of the synthetic data compared to schema of the real data), field grouping(s) of the data (e.g., field level relationships of the synthetic data compared to field level relationships of the real data).

In some non-limiting embodiments or aspects, if differential privacy is needed and/or requested for the request for synthetic data, synthetic data generation system 506a may verify the synthetic data based on synthetic data verification system 506-3 and differential privacy verification system 506-4. For example, differential privacy verification system 506-4 may determine a privacy re-identification risk associated with the synthetic data. Synthetic data verification system 506-3 may verify the synthetic data based on the metric(s) and the privacy re-identification risk. In some non-limiting embodiments or aspects, determining a privacy re-identification risk may include determining whether the synthetic data is deterministic or stochastic. For example, being stochastic may be associated with less privacy re-identification risk than deterministic.

In some non-limiting embodiments or aspects, a threshold level of privacy re-identification risk may be a parameter of the request for generation of the synthetic data. For example, the threshold may be associated with a customized balance of privacy with quality of the synthetic data (e.g., increased privacy may correlate with reduced accuracy, and vice versa). In some non-limiting embodiments or aspects, differential privacy verification system 506-4 may determine whether the calculated privacy re-identification risk satisfies the threshold.

In some non-limiting embodiments or aspects, all information related to verification of the synthetic data by synthetic data generation system 506a (e.g., synthetic data verification system 506-3 thereof) may be captured (e.g., stored) in synthetic data storage system 510a (e.g., request specific synthetic verification data 510-4 of synthetic data storage system 510a).

In some non-limiting embodiments or aspects, synthetic data generation system 506a and/or the subsystems thereof (e.g., synthetic data engine system 506-1, differential privacy system 506-2, synthetic data verification system 506-3, and/or differential privacy verification system 506-4) may include a combination of CPUs and GPUs, e.g., for synthetic data generation and verification.

In some non-limiting embodiments or aspects, in response to verifying the synthetic data, the synthetic data may be communicated to the user. For example, verification system 506b may determine (e.g., confirm) that the synthetic data (e.g., request specific synthetic data 510-3 stored in synthetic data storage system 510a) has been verified (e.g., based on request specific synthetic verification data 510-4 stored in synthetic data storage system 510a). Based on determining that the synthetic data has been verified, data release system 506c may communicate the synthetic data (e.g., request specific synthetic data 510-3 obtained from synthetic data storage system 510a and/or verification system 506b) to user device 502a and/or requesting system 502b (e.g., a system associated with the user of user device 502a for which the user requested the synthetic data).

In some non-limiting embodiments or aspects, access API 504b may allow requesting system 502b to communicate with request handling system 504a, preprocessing system 504c, data release system 506c, any other system or component of system 500, and/or the like. In some non-limiting embodiments or aspects, requesting system 502b may communicate requests for synthetic data to request handling system 504a (e.g., in addition to or in lieu of the request from user device 502a). For example, requesting system 502b may communicate at least one automated request for synthetic data (e.g., periodically, in response to at least one triggering event, and/or the like). In some non-limiting embodiments or aspects, requesting system 502b may already have stored therein and/or may determine (e.g., automatically determine) the parameter(s) for a request (e.g., automated request), and therefore, the request can bypass at least a portion of request handling system 504a (e.g., bypass parameter recommendation system 504-3 of request handling system 504a), for example, so that the request may proceed directly to preprocessing system 504c.

In some non-limiting embodiments or aspects, in response to determining (e.g., by verification system 506b) whether or not the synthetic data has been verified, all information related to that determination may be captured (e.g., stored) in request management system 504e. In some non-limiting embodiments or aspects, request management system 504e may communicate with user device 502a based on the determination. For example, request management system 504e may transmit at least one communication to user device 502a indicating success or failure (e.g., synthetic data was successfully created and verified or not) of the request for synthetic data.

In some non-limiting embodiments or aspects, request management system 504e may capture information (e.g., all information, logs based on the information, and/or the like) related to the entire process from receiving the request from user device 502a to release (or non-release) of the synthetic data to the user. For example, request management system 504e may store such captured information. Additionally or alternatively, request management system 504e may cause such captured information to be stored in synthetic data storage system 510a (e.g., a request management data structure in synthetic data storage system 510a).

In some non-limiting embodiments or aspects, reporting system 504f may generate at least one report. For example, reporting system 504f may generate the reports(s) based on the information captured by request management system 504e. For the purpose of illustration, an example report may include at least one of an operational reporting (e.g., a number of requests, timing of such request(s), service level reports (e.g., for each request), a number of requests and/or reports per requester (e.g., user device 502a or requesting system 502b, and/or the like), verification reports per request (e.g., indicating whether synthetic data was successfully generated and verified or not), a visualization report (e.g., Power BI report, Tableau reports, and/or the like), any combination thereof, and/or the like.

In some non-limiting embodiments or aspects, machine learning model training system 508 may train (e.g., pre-train and/or the like) a plurality of machine learning models (e.g., synthetic data generation models), as described herein.

In some non-limiting embodiments or aspects, machine learning model training system 508 may monitor and refresh (e.g., retrain, fine tune, and/or the like) existing machine learning models (e.g., in the case that they become stale, in case their performance deteriorates (e.g., synthetic data fails verification), and/or the like). For example, after a machine learning model is trained, model evaluation system 508-1 may evaluate the trained machine learning model based on a separate test dataset to measure the performance of the trained machine learning model. For example, performance may be evaluated based on at least one metric, such as an accuracy metric, a precision metric, a recall metric, an F1 score, any combination thereof, and/or the like.

In some non-limiting embodiments or aspects, model selection system 508-2 may determine (e.g., select) a suitable machine learning model from the plurality of machine learning models available in machine learning model system 508 based on the request for synthetic data (e.g., based on at least one parameter of the request and/or the like).

In some non-limiting embodiments or aspects, model training system 508-3 may train (and/or retrain) a machine learning model, as described herein. In some non-limiting embodiments or aspects, the machine learning model may be pretrained before receiving a request for generation of synthetic data. In some non-limiting embodiments or aspects, the machine learning model may be trained (or retrained) in response to receiving a request for generation of synthetic data. For example, the machine learning model may be trained using the preprocessed data (e.g., real data) from preprocessing system 504c (e.g., received at machine learning model training system 508 via engine API 504d and/or synthetic data generation system 506a).

In some non-limiting embodiments or aspects, model tuning system 508-4 may finetune a machine learning model. For example, after training by model training system 508-3, model tuning system 508-4 may finetune the machine learning model based on the evaluation by model evaluation system 508-1.

In some non-limiting embodiments or aspects, machine learning model training system 508 and/or the subsystems thereof (e.g., model evaluation system 508-1, model selection system 508-2, model training system 508-3, and/or model tuning system 508-4) may include a GPU or other type of processor suitable for parallel processing of a large volume of data (e.g., for training the machine learning model(s)).

In some non-limiting embodiments or aspects, enterprise data storage system 510b may include (e.g., store) a data catalog of all data (e.g., real data, synthetic data, and/or the like) available at an enterprise level (e.g., at the level of the entity that controls system 500, such as a transaction service provider and/or the like). For example, the data from synthetic data storage system 510a and/or records based thereon (e.g., logs, index data, and/or the like) may be stored in enterprise data storage system 510b. For the purpose of illustration, the data catalog may include a name of each dataset of synthetic data generated and/or verified by system 500, a description of each such dataset, at least one retention parameter for each such dataset, a mapping of data in each such dataset to business terms, any combination thereof, and/or the like. In some non-limiting embodiments or aspects, the data catalog may include the fields to be included (e.g., based on the request for generation of synthetic data) as part of the parameter set (e.g., the SELECT commands, as described herein).

In some non-limiting embodiments or aspects, source data storage system(s) 510c may be part of enterprise data storage system 510b. Additionally or alternatively, enterprise data storage system 510b may store records (e.g., logs, index data, and/or the like) based on data in data storage system(s) 510c.

In some non-limiting embodiments or aspects, system 500 may generate and/or synthetic data storage system 510a may store synthetic core data 510-5, which may include automatically generated synthetic datasets for selected types of data that may be useful to multiple different users and/or requesting systems 502b. For example, a transaction service provider may be aware of multiple types of synthetic data that may be useful for many applications (e.g., to train multiple different downstream models, to perform research, and/or the like). For the purpose of illustration, system 500 may automatically generate (e.g., periodically, in response to at least one triggering event, without receiving a request for generation of synthetic data, and/or the like) synthetic core data 510-5 associated with authorizations of transactions (e.g., authorization requests), clearing/settlement of transactions, fraud, authentication, code tables, any combination thereof, and/or the like. In some non-limiting embodiments or aspects, subscription system 506d may communicate with at least one subscriber (e.g., user device 502a, requesting system 502b, and/or the like) based on the automatically generated synthetic data. For example, subscription system 506d may communicate such automatically generated synthetic data to the subscriber (e.g., upon generation thereof). Additionally or alternatively, subscription system 506d may communicate a message to the subscriber indicating the availability of the synthetic core data 510-5 in synthetic data storage system 510a.

In some non-limiting embodiments or aspects, at least one other (e.g., downstream) machine learning model may be trained based on the synthetic data, as described herein. For example, the other machine learning model(s) may include at least one of a fraud detection model, a risk detection model, a transaction authorization model, a credit approval model, a product recommendation model, a classifier model, an anomaly detection model, an authentication model, any combination thereof, and/or the like.

In some non-limiting embodiments or aspects, a transaction message may be received (e.g., by a transaction processing system, as described herein). At least one action may be performed based on the transaction message and the other machine learning model(s) (e.g., that has been trained based on the synthetic data). For example, the other machine learning model(s) may include a fraud detection model. Performing the action(s) may include denying a transaction associated with the transaction message based on inputting the transaction message (or an input based on transaction message) to the fraud detection model (e.g., that has been trained based on the synthetic data). For example, the fraud detection model may generate a prediction that the transaction is fraudulent, and the transaction may be denied based on the prediction.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method, comprising:
receiving, with at least one processor, a request for generation of synthetic data from a user;
generating, with at least one processor, a plurality of possible parameters for the synthetic data;
determining, with at least one processor, at least one parameter based on the plurality of possible parameters and at least one input from the user;
determining, with at least one processor, at least one machine learning model from a plurality of machine learning models based on the at least one parameter, the plurality of machine learning models trained based on real data;
generating, with at least one processor, the synthetic data based on the at least one machine learning model and the at least one parameter;
verifying, with at least one processor, the synthetic data based on at least one of: the at least one parameter, the real data, or any combination thereof; and
in response to verifying the synthetic data, communicating, with at least one processor, the synthetic data to the user.

2. The method of claim 1, wherein the plurality of possible parameters comprises at least one of the following: an engine parameter associated with one or more of the plurality of machine learning models, an operational parameter, a file location parameter, an access parameter, a descriptive parameter associated with at least a portion of the real data, field grouping data associated with at least two fields of the real data, a privacy parameter, an output of a large language model, or any combination thereof.

3. The method of claim 2, wherein the field grouping data is based on a decision tree based on the at least two fields of the real data.

4. The method of claim 2, wherein the output of the large language model is associated with at least one recommended parameter based on at least one of the following: the real data, the at least one input from the user, or any combination thereof.

5. The method of claim 1, wherein each respective machine learning model of the plurality of machine learning models is trained based on a respective portion of the real data associated with a respective cluster of entities of a plurality of entities associated with the real data.

6. The method of claim 1, further comprising determining at least one metric associated with the synthetic data and at least one metric associated with the real data, wherein verifying the synthetic data comprises comparing the at least one metric associated with the synthetic data and the at least one metric associated with the real data.

7. The method of claim 1, further comprising determining a privacy re-identification risk associated with the synthetic data, wherein verifying the synthetic data is further based on the privacy re-identification risk.

8. The method of claim 7, further comprising determining at least one metric associated with the synthetic data, wherein verifying the synthetic data is based on the at least one metric associated with the synthetic data and the privacy re-identification risk.

9. The method of claim 1, further comprising:
training at least one other machine learning model based on the synthetic data.

10. The method of claim 9, further comprising:
receiving a transaction message; and
performing at least one action based on the transaction message and the at least one other machine learning model trained based on the synthetic data.

11. The method of claim 10, wherein the at least one other machine learning model comprises a fraud detection model, and wherein performing the at least one action comprises denying a transaction associated with the transaction message based on inputting an input based on the transaction message to the fraud detection model trained based on the synthetic data.

12. A system, comprising:
at least one processor configured to:
receive a request for generation of synthetic data from a user;
generate a plurality of possible parameters for the synthetic data;
determine at least one parameter based on the plurality of possible parameters and at least one input from the user;
determine at least one machine learning model from a plurality of machine learning models based on the at least one parameter, the plurality of machine learning models trained based on real data;
generate the synthetic data based on the at least one machine learning model and the at least one parameter;
verify the synthetic data based on at least one of: the at least one parameter, the real data, or any combination thereof; and
in response to verifying the synthetic data, communicate the synthetic data to the user.

13. The system of claim 12, wherein the plurality of possible parameters comprises at least one of the following: an engine parameter associated with one or more of the plurality of machine learning models, an operational parameter, a file location parameter, an access parameter, a descriptive parameter associated with at least a portion of the real data, field grouping data associated with at least two fields of the real data, a privacy parameter, an output of a large language model, or any combination thereof.

14. The system of claim 13, wherein the field grouping data is based on a decision tree based on the at least two fields of the real data.

15. The system of claim 13, wherein the output of the large language model is associated with at least one recommended parameter based on at least one of the following: the real data, the at least one input from the user, or any combination thereof.

16. The system of claim 12, wherein each respective machine learning model of the plurality of machine learning models is trained based on a respective portion of the real data associated with a respective cluster of entities of a plurality of entities associated with the real data.

17. The system of claim 12, wherein the at least one processor is further configured to:
determine at least one metric associated with the synthetic data and at least one metric associated with the real data, wherein verifying the synthetic data comprises comparing the at least one metric associated with the synthetic data and the at least one metric associated with the real data.

18. The system of claim 12, wherein the at least one processor is further configured to:
determine a privacy re-identification risk associated with the synthetic data, wherein verifying the synthetic data is further based on the privacy re-identification risk.

19. The system of claim 12, wherein the at least one processor is further configured to:
train at least one other machine learning model based on the synthetic data;
receive a transaction message; and
perform at least one action based on the transaction message and the at least one other machine learning model trained based on the synthetic data,
wherein the at least one other machine learning model comprises a fraud detection model, and wherein performing the at least one action comprises denying a transaction associated with the transaction message based on inputting an input based on the transaction message to the fraud detection model trained based on the synthetic data.

20. A computer program product comprising at least one non-transitory computer-readable medium including program instructions that, when executed by at least one processor, cause the at least one processor to:
receive a request for generation of synthetic data from a user;
generate a plurality of possible parameters for the synthetic data;
determine at least one parameter based on the plurality of possible parameters and at least one input from the user;
determine at least one machine learning model from a plurality of machine learning models based on the at least one parameter, the plurality of machine learning models trained based on real data;
generate the synthetic data based on the at least one machine learning model and the at least one parameter;
verify the synthetic data based on at least one of: the at least one parameter, the real data, or any combination thereof; and
in response to verifying the synthetic data, communicate the synthetic data to the user.
